(19) United States
(12) Patent Application Publication
(10) Pub. No.: US 2012/0103151 A1
(43) Pub. Date: May 3, 2012

(54) Composition Dispensing Device Comprising A Non-Foaming Hydrating Composition

(76) Inventors: Neil John Jones, Staines (GB); Alison Fiona Stephens, Maidenhead (GB); James Robert Schwartz, West Chester, OH (US)

(21) Appl. No.: 13/280,660

(22) Filed: Oct. 25, 2011

Related U.S. Application Data
(60) Provisional application No. 61/524,088, filed on Aug. 16, 2011.
(60) Provisional application No. 61/407,111, filed on Oct. 27, 2010.

(51) Int. Cl. B26D 7/08

(52) U.S. Cl. 83/22; 83/169

(57) ABSTRACT

A composition dispensing device containing a composition comprising an anti-irritation agent such as zinc pyrithione. which is preferably thick and viscous yet remains clear or translucent.

### CROSS REFERENCE TO RELATED APPLICATIONS

This patent claims priority to U.S. Provisional Application No. 61/524,088 filed Aug. 16, 2011, which claims priority to U.S. Provisional Application No. 61/407,111 filed Oct. 27, 2010.

### BACKGROUND OF THE INVENTION

Several different composition dispensing razors are known. See, e.g., U.S. Pat. Nos. 7,007,389; 6,308,413; 4,753,006; 4,635,361; 6,986,207; 5,855,066; and 4,129,942. These and other dispensing razors have been described as being capable of dispensing various types of shaving related preparations, including clear or translucent shaving gels or lotions.

For example, composition dispensing shavers having a plurality of shaver heads with rotary blade cutters capable of dispensing a lubricant for allegedly decreasing friction between the shaving heads and cutters with skin has been disclosed in U.S. Patent Publ. No. 2008/0216322 and RE038934. Additionally, Phillips Norelco recently marketed a composition dispensing razor under the name of Cool Skin Shaver®. This shaver has a large main head containing multiple rotary blades and dispenses a Nivea For Men® moisturizing shave lotion out of the center of the rotary blades, allowing the composition to coat the shaving head and cutters to allegedly decrease friction with skin.

A runny or less viscous formulation may be desirable in certain instances, such as where the formulator wants the composition to dispense in a discrete area but quickly spread to contact and/or coat a large surface, such as the shaving head and cutters. It can also be desirable, however, for the product to be sufficiently thick so it will not run off or otherwise be pushed away from the portion of skin desired for treatment. Many different types of thickeners and viscosity modifying agents can impact the viscosity and rheology of the composition. Many of these ingredients, however, also impact other characteristics of the composition when added, such as making the composition stringy or tacky, or making the composition cloudy or opaque. Examples of numerous clear and/or non-foaming skin care compositions of varying thickness and viscosity are known. See e.g. WO 93/18740; GB 2236760; U.S. Pat. Nos. 2,833,693; 3,072,536; 4,585,650; 4,917,844; and 6,627,185.

One class ingredients which is believed to provide desirable thickening benefits as well as cleansing and lathering benefits includes surfactants. Many of these surfactants, however, are capable of causing undesirable skin irritation during and following use in certain instances. This can be particularly relevant where users do not wash off the composition from skin following the hair removal process. Further, many foaming compositions can also cause visibility of the surface to be obscured as a result of the foam.

The number of combinations of devices and compositions is numerous. In addition, if one were to further consider the many different types of personal care compositions which can be used, the number of executions can be near limitless. Despite the near limitless number of potential combinations of features, there remains a need for a composition dispensing device capable of dispensing a composition which is sufficiently thick and viscous yet is not undesirably cloudy or opaque.

### SUMMARY OF THE INVENTION

One aspect of the present invention provides for a composition dispensing device comprising: a non-foaming, hydrating composition contained within said first chamber, said non-foaming, hydrating composition comprising: at least about 80% water by weight of the non-foaming, hydrating composition; sufficient thickener to give the non-foaming, hydrating composition a viscosity of at least 10,000 cps, and at most 200,000 cps measured using a Brookfield DVII Viscometer using a T-A spindle at 2.5 rpm at 25° C.; less than about 1% hydrophobic components, by weight of the non-foaming, hydrating composition; and less than about 1% surfactant, by weight of the non-foaming, hydrating composition. Any composition contained in said device can also optionally comprise an anti-irritation agent comprising a pyrithione, a polyvalent metal salt of pyrithione, and a mixture thereof.

In one embodiment, the composition dispensing device comprises a handle connected to a hair removal head, the handle further comprising a cavity for housing said non-foaming hydrating composition disposed within the handle, and an actuator adapted to displace non-foaming hydrating composition from the cavity to a fluid dispensing member, and wherein said fluid dispensing member comprises an elongated elastomeric contact region forming at least one dispensing orifice which is generally perpendicular to a transverse centerline of the handle.

Another aspect provides for a method of removing hair from skin comprising the steps of: providing a composition dispensing device containing the non-foaming, hydrating composition of the present invention; actuating said composition dispensing device to dispense said composition; contacting said composition onto a portion of skin to be treated to form a prepared surface; and contacting said prepared surface with the razor blade of the composition dispensing device to form a treated surface.

### BRIEF DESCRIPTION OF THE DRAWINGS

FIG. 1 is a side view of a composition dispensing device suitable for use with the non-foaming hydrating composition in accordance with at least one embodiment of the present invention.

FIGS. 2 and 3 are side views of other embodiments suitable for use as the composition dispensing device.

FIG. 4 is a side view of the composition dispensing device shown in FIG. 3, but where the device is in use on a segment of skin;

FIGS. 5, 6 and 7 are various bottom planar views composition dispensing devices in accordance with one or more embodiments of the present invention.

FIG. 8 is an exploded side view of portion of a fluid dispensing member.

FIG. 9 is a planar view of the contact region of the fluid dispensing member of FIG. 8.

### DETAILED DESCRIPTION OF THE INVENTION

It has importantly been found that when selecting a composition to be used in a composition dispensing device, it can be particularly desirable to select a composition which is sufficiently thick and viscous that it will not run off the skin after being dispensed. Further, it can be desirable for this composition to have a clear or translucent appearance when dispensed onto skin so the surface under the composition is not unduly obscured from view. Further, it can be desirable for certain ingredients to be minimized or removed from the composition such that skin irritation is decreased. In another embodiment, the composition can be formulated to be less stringy. One way to do this is to provide low to nil levels of certain ingredients, such as lubrication polymers.

1. Non-Foaming Hydrating Composition

The product dispensed by the composition dispensing device is a non-foaming hydrating composition suitable for dermatological use. The inventors have established that the presence of hydrophobic components within the viscous, aqueous composition may militate against the hydration effects of the water and tend to increase the force needed to cut a hair to which the composition has been applied. Without wishing to be bound by theory, it is believed that the hydrophobic components may preferentially associate with the hydrophobic sebum on the surface of the hair and make it more difficult for the razor blades to gain a purchase. In other words, the blades may have an increased tendency to glide over the hair and cut further down the hair stem from the root or not at all. Ideally, therefore, the viscous, aqueous composition used in the method of the present invention will comprise no hydrophobic components. In practice, consumers often like products to be applied to their skin to have a pleasant smell and, since fragrance oils are generally hydrophobic, a small amount of hydrophobic component is necessary for perfumed compositions.

As used herein, the term “hydrophobic components” includes oils, including hydrocarbon oils, and silicone oils; fats; fatty alcohols, acids and esters; petrolatum and waxes.

A beneficial side-effect of the fact that the compositions used in the method according to the invention contain little or no hydrophobic components is that the composition may additionally comprise little to no surfactant, i.e. lathering surfactants or non-lathering surfactants, to emulsify the hydrophobic components. Surfactants are skin irritants and so their exclusion assists in reducing skin irritation. In addition, surfactants bind water so may tend to reduce the amount of water available for hydration of the hair. In any case, the present compositions comprise insufficient surfactant for them to foam in use.

Compositions used in the method of the invention comprise as much water as possible in order to achieve the objective of hydrating the skin. Typically, the compositions comprise at least 80%, preferably at least 90% and more preferably at least 95% water by weight of the non-foaming, hydrating composition. Without intending to be bound by theory, it is believed that providing a composition with such a high level of water can be beneficial as it may expose the skin to more water and provide better and/or faster hydration than compositions with high levels of other ingredients such as surfactants, polymers, or other ingredients commonly used in skin care compositions. The complexity with having a high level of water is that many of the other ingredients which would otherwise be present are not removed. These ingredients could have been previously included to maintain desirable rheology and appearance. As such, new thickening systems may be used to compensate for the removal of other ingredients where high levels of water are used.

Compositions used in the method of the invention may be thickened in any appropriate way to provide them with a viscosity in the range from 10,000 to 200,000 cps, preferably 50,000 to 100,000 cps measured using a Brookfield DVII Viscometer using a T-A spindle at 2.5 rpm at 25° C. One appropriate way to thicken such compositions is to thicken them to form a hydrogel. Preferably, the hydrogel is based on polyacrylic acid. Preferred hydrogels are thickened using Carbopol or a Pemulen. The thickener concentration from about 0.1% to about 5%, or from about 0.1% to about 4%, or from about 0.25% to about 3%, by weight of the non-foaming, hydrating composition. Nonlimiting classes of thickening agents include those selected from the following: Carboxylic Acid Polymers, Crosslinked Polyacrylate Polymers Polyacrylamide Polymers, Polysaccharides, Clays and Gums, and mixtures thereof when appropriate. In another embodiment, compositions of the present invention include a thickening agent selected from carboxylic acid polymers, crosslinked polyacrylate polymers, polyacrylamide polymers, polysaccharides, and mixtures thereof, more preferably selected from carboxylic acid polymers, polyacrylamide polymers, polysaccharides, and mixtures thereof. One example of a suitable thickening agent is Acrylates/C10-30 Alkyl Acrylate Crosspolymer (also known as Ultrez 21 and ETD2020). If a carbomer, such as Carbopol (also known as Utrez 10), is used, then it is advantageously associated with a base, such as triethanolamine.

Without intending to be bound by theory, it is believed that the thickener of the present invention allows the composition to have the desired viscosity such that after it is dispensed from the device onto skin, the composition will be less likely to run or drip off. As such, the composition will stay on the portion of skin desired to be treated and hydrated prior to any hair being removed. This is particularly beneficial when compared to compositions which are not sufficiently viscous as they will tend to run and drip down the user's skin requiring extra product to be dispensed to ensure the desired contact onto skin. Further, allowing the composition to stay in the vicinity of the cartridge or dispensing member is important as loss of the composition to premature drippage or run off down the device can be unsightly and make the device undesirably slippery and difficult to use.

In one embodiment, the present composition comprises less than about 5% of one or more lathering surfactants, or less than about 3%, or less than about 2%, or less than about 1.5%, or less than about 1%, or less than about 0.5%. In another embodiment, the present composition is free or substantially free of lathering surfactants. A lathering surfactant is defined herein as surfactant, which when combined with water and mechanically agitated generates a foam or lather. Lathering surfactants include those selected from the group consisting of anionic lathering surfactants, amphoteric lathering surfactants, and mixtures thereof. Generally, the lathering surfactants are fairly water soluble. Examples of anionic lathering surfactants are disclosed in McCutcheon's, Detergents and Emulsifiers, North American edition (1986), published by allured Publishing Corporation; McCutcheon's, Functional Materials, North American Edition (1992); and U.S. Pat. No. 3,929,678. A wide variety of anionic lathering surfactants are useful herein. Non-limiting examples of anionic lathering surfactants include those selected from the group consisting of sarcosinates, sulfates, sulfonates, isethionates, taurates, phosphates, lactylates, glutamates, and mixtures thereof. Other anionic materials useful herein are soaps (i.e., alkali metal salts, e.g., sodium or potassium salts) of fatty acids, typically having from about 8 to about 24 carbon atoms, preferably from about 10 to about 20 carbon atoms, monoalkyl, dialkyl, and trialkylphosphate salts, alkanoyl sarcosinates. Examples of zwitterionic or amphoteric surfactants are described in U.S. Pat. Nos. 5,104,646 and 5,106,609. Other surfactants commonly used in skin care compositions, which may fall outside this definition of a lathering surfactant, can also be controlled at the same levels.

By limiting the amount of lathering surfactants, it is believed that the composition is less likely to having skin irritation issues. This can be particularly desirable where the composition is designed to allow the user to leave the composition on the skin as a leave on or where the user is not able to wash or rinse their skin following use. Without intending to be bound by theory, it is believed that even low levels of surfactant left on skin can cause some skin irritation. By limiting or removing lathering surfactants and/or any surfactants from the present composition, the formulation is less likely to cause skin irritations.

Advantageously, compositions used in the method of the invention comprise a humectant. Suitable humectants include polyhydric alcohols such as glycerine, propylene glycol, dipropylene glycol, polypropylene glycol, polyethylene glycol, sorbitol, hydroxypropyl sorbitol, hexylene glycol, 1,3-butylene glycol, 1,2,6-hexanetriol, ethoxylated glycerin, propoxylated glycerine and mixtures thereof. Most preferably the humectant comprises glycerine.

It can also be advantageous to add a lubricating polymer to compositions used in the method of the invention. As used herein, a “lubricating polymer” is a linear polymer having a molecular weight from 100,000 to 7,000,000 which swells when added to water. Non-limiting examples of such polymers are polyoxyethylene, such as POLYOX, and polyoxypropylene.

In one embodiment, however, the composition comprises less than about 5%, or less than about 2%, or less than about 1%, or less than about 0.5%, or less than about 0.1%, or is free or essentially free of a lubricating polymer, such as polyoxyethylene, polyoxypropylene. Without intending to be bound by theory, it is believed that although these lubricating polymers provide useful lubrication, they can also cause the composition to be stringy. This stringiness can be undesirable for certain consumers.

Compositions used in the method according to the invention may comprise a variety of additional optional water-soluble ingredients. Non-limiting examples of these additional ingredients include additional water soluble skin care actives such as peptides, vitamins and derivatives thereof such ascorbic acid, vitamin A, vitamin B₃ (e.g., niacinamide) and vitamin B₅ (e.g., panthenol); antioxidants; skin soothing and healing agents such as aloe vera extract, allantoin and the like; chelators and sequestrants.

The non-foaming, hydrating composition can also contain one or more other benefit agents. Suitable benefit agents for skin and/or hair for inclusion into the fluid of the razor are disclosed in U.S. Pat. No. 6,789,321. For instance, suitable agents include but are not limited to shaving soaps, lubricants, skin conditioners, skin moisturizers, hair softeners, hair conditioners, fragrances, skin cleansers, bacterial or medical lotions, blood coagulants, anti-inflammatories, astringents, and combinations thereof. In another embodiment, where a more simple formulation is desired, the composition can be free or essentially free of one of more of these agents. Free of an ingredient, as defined herein, means that no amount of that ingredient is intentionally added but trace amounts can be present as carryover from processing or other ingredient feeds.

The composition can further comprise additional optional ingredients. Suitable additional optional ingredients include perfume, preservatives, chelants, sensates (e.g. menthol), desquamation actives, anti-acne actives, anti-wrinkle/anti-atrophy actives, anti-oxidants/radical scavengers, flavonoids, anti-inflammatory agents, anti-cellulite agents, topical anesthetics, tanning actives, skin lightening agents, skin soothing and healing actives, antimicrobial actives, sunscreen actives, visual skin enhancers, humectants and moisturizing agents (e.g., glycerin, glycols, sorbitol) and the like. Such optional ingredients are described more fully in U.S. Patent Publ. No. 2006/0239953. Preferred additional optional ingredients include salicylic acid, opacifiers (e.g. mica and titanium dioxide), perfume, hydrophilic conditioning agents (e.g., glycerin) and skin sensates (e.g. menthol).

The composition may also contain salicylic acid, its isomers, tautomers, salts and derivatives thereof at a level of from about 0.001% to about 5% or from about 0.01% to about 2%, or from about 0.1% to about 1%. Without wishing to be bound by theory, it is believed that salicylic acid is efficacious for the treatment of acne on the skin. Moreover, the salicylic acid is capable of treating and/or reducing the presence of acne on the skin Such treatment with the shave preparation of this invention involves applying the shave preparation to the skin and shaving the skin that has been treated with the shave preparation.

Dermatologically acceptable salts may also be included, such as alkali metal salts, such as sodium and potassium; alkaline earth metal salts, such as calcium and magnesium; non-toxic heavy metal salts; ammonium and trialkylammonium salts such as trimethylammonium and triethylammonium. Derivatives of salicylic acid include, but are not limited to, any compounds wherein the CH3 groups are individually or in combination replaced by amides, esters, amino groups, alkyls, and alcohol esters. Tautomers of salicylic acid are the isomers of salicylic acid which can change into one another with ease so that they ordinarily exist in equilibrium. Thus, tautomers of salicylic acid can be described as having the chemical formula C7H6O3 and generally having a similar structure to salicylic acid.

The compositions of the present invention may also include from about 0.001% to about 5%, alternatively from about 0.01% to about 2%, and alternatively from about 0.1% to about 1%, of alpha- or beta-hydroxy acids, and derivatives, salts, isomers and tautomers thereof. Non-limiting examples of alpha- and beta-hydroxy acids include alpha-hydroxy-butyric acid, alpha-hydroxyisobutyric acid, alpha-hydroxyisocaproic acid, alpha-hydroxyisovaleric, atrolactic acid, beta-hydroxybutyric acid, beta-phenyl lactic acid, beta-phenylpyruvic acid, citric acid ethyl pyruvate, galacturonic acid, glucoheptonic acid, glucoheptono 1,4-lactone, gluconic acid, gluconolactone glucuronic acid, glucuronolactone, glycolic acid, isopropyl pyruvate, lactic acid, malic acid, amndelic acid, emthyl pyruvate, mucic acid, pyruvic acid, saccharic acid, saccharic acid 1,4-lactone, tartaric acid and tartronic acid, and mixtures thereof.

Where a visual contrast between areas of the skin that have and have not been shaved is desired, opacifiers may be added to the composition. Opacifiers may be either inorganic or organic compounds. Inorganic opacifiers include, for example, titanium dioxide, zinc oxide, talc, mica or coated mica (with oxides of titanium, tin, or iron or bismuth oxychloride), magnesium aluminum silicate, bismuth oxychloride, or other minerals. These compounds can be added as powders, dispersions, or complexes. Organic opacifiers include, for example, opaque emulsions (e.g., containing Styrene/PVP copolymer, vinyl polymers, or latexes), metal salts of amines containing 14-20 carbon atoms per molecule, alkanolamides containing 14-20 carbon atoms per molecule, organic alcohols containing 14-20 carbon atoms per molecule, insoluble salts of stearic acid, glycol mono- or distearates, propylene glycol and glycerol monostearates and palmitates. Combinations of these opacifiers can also be used. The opacifying additive is typically included in an amount of about 1 to about 6%, preferably about 2 to about 5%, by weight of the composition.

a. Anti-Irritation Agent

In one embodiment the non-foaming, hydrating composition of the present invention further comprises an anti-irritation agent. The anti-irritation agent can be pyrithione or a polyvalent metal salt of pyrithione, or a mixture thereof. Any form of polyvalent metal pyrithione salts may be used, including platelet and needle structures. Preferred salts for use herein include those formed from the polyvalent metals magnesium, barium, bismuth, strontium, copper, zinc, cadmium, zirconium and mixtures thereof, more preferably zinc. Even more preferred for use herein is the zinc salt of 1-hydroxy-2-pyridinethione (known as “zinc pyrithione” or “ZPT”); more preferably ZPT in platelet particle form, wherein the particles have an average size of up to about 20 μm, preferably up to about 5 μm, more preferably up to about 2.5 μm.

Pyridinethione anti-microbial and anti-dandruff agents are described, for example, in U.S. Pat. No. 2,809,971; U.S. Pat. No. 3,236,733; U.S. Pat. No. 3,753,196; U.S. Pat. No. 3,761,418; U.S. Pat. No. 4,345,080; U.S. Pat. No. 4,323,683; U.S. Pat. No. 4,379,753; and U.S. Pat. No. 4,470,982.

The platelet ZPT includes a median particle diameter of about 0.5 microns to about 10, alternatively about 1 to about 5 microns, and alternatively about 3 microns; a mean particle diameter of about 0.5 to about 10 microns, alternatively about 1 to about 5 microns, alternatively about 2 to about 4 microns, and alternatively about 3 microns, and a thickness of about 0.6 to about 15 microns, alternatively about 0.6 to 1 micron, alternatively about 0.6 to about 0.8, and alternatively about 0.6 to about 0.7 microns. The platelet ZPT can also have a span of less than about 5, and alternatively about 1.

Preferred embodiments include from 0.01% to 5% of an anti-irritation agent; alternatively from 0.05% to 2%, alternatively from 0.1% to 1%, alternatively from 0.2% to about 0.7%, alternatively about 0.5%.

The composition of the present invention optionally includes an effective amount of a zinc salt. Preferred embodiments of the present invention include an effective amount of a zinc salt having an aqueous solubility within the composition of less than about 25%, by weight, at 25° C., more preferably less than about 20%, more preferably less than about 15%. Preferred embodiments of the present invention include from 0.001% to 10% of a zinc salt, more preferably from 0.01% to 5%, more preferably still from 0.1% to 3%. In a preferred embodiment, the zinc salt has an average particle size of from 100 nm to 30 μm.

Examples of zinc salts useful in certain embodiments of the present invention include the following: Zinc aluminate, Zinc carbonate, Zinc oxide and materials containing zinc oxide (i.e., calamine), Zinc phosphates (i.e., orthophosphate and pyrophosphate), Zinc selenide, Zinc sulfide, Zinc silicates (i.e., ortho- and meta-zinc silicates), Zinc silicofluoride, Zinc Borate, Zinc hydroxide and hydroxy sulfate, zinc-containing layered materials and combinations thereof.

In embodiments having an anti-irritation agent and a zinc salt, the ratio of zinc salt to anti-irritation agent is preferably from 5:100 to 5:1; more preferably from about 2:10 to 3:1; more preferably still from 1:2 to 2:1.

Those of skill in the art will understand that the anti-irritation agent of the present invention can also have other benefits which may be desirable from a skin care composition, including but not limited to malodor control and/or anti-bacterial benefits depending on whether the composition is left on skin or rinsed off.

Without intending to be bound by theory, it is believed that these anti-irritation agents can provide various benefits including reduction or control of irritation as well as certain malodor control. In one embodiment, the composition further comprises other agents such as malodor control agents. The malodor active of the present invention is capable of providing an antimicrobial benefit. Such malodor actives are capable of destroying microbes, preventing the development of microbes or preventing the pathogenic action of microbes. A safe and effective amount of a malodor active may be added to the intimate cleansing product, at from about 0.001% to about 10%, or from about 0.01% to about 5%, or from about 0.05% to about 2%, or from about 0.1% to about 1%, or from about 0.3% to about 0.7%, or about 0.5% by weight of the composition.

Examples of malodor actives include β-lactam drugs, quinolone drugs, ciprofloxacin, norfloxacin, tetracycline, erythromycin, amikacin, 2,4,4′-trichloro-2′-hydroxy diphenyl ether, 3,4,4′-trichlorobanilide, phenoxyethanol, phenoxy propanol, phenoxyisopropanol, doxycycline, capreomycin, chlorhexidine, chlortetracycline, oxytetracycline, clindamycin, ethambutol, hexamidine isethionate, metronidazole, pentamidine, gentamicin, kanamycin, lincomycin, methacycline, methenamine, minocycline, neomycin, netilmicin, paromomycin, streptomycin, tobramycin, miconazole, tetracycline hydrochloride, erythromycin, zinc erythromycin, erythromycin estolate, erythromycin stearate, amikacin sulfate, doxycycline hydrochloride, capreomycin sulfate, chlorhexidine gluconate, chlorhexidine hydrochloride, chlortetracycline hydrochloride, oxytetracycline hydrochloride, clindamycin hydrochloride, ethambutol hydrochloride, metronidazole hydrochloride, pentamidine hydrochloride, gentamicin sulfate, kanamycin sulfate, lincomycin hydrochloride, methacycline hydrochloride, methenamine hippurate, methenamine mandelate, minocycline hydrochloride, neomycin sulfate, netilmicin sulfate, paromomycin sulfate, streptomycin sulfate, tobramycin sulfate, miconazole hydrochloride, ketaconazole, amanfadine hydrochloride, amanfadine sulfate, octopirox, parachlorometa xylenol, nystatin, tolnaftate, clotrimazole, and mixtures thereof.

According to the method of the invention, a person may shave their face using a product dispensing razor comprising a non-foaming, hydrating composition with or without the addition of any water (i.e. as a wet shaving device or a dry shaving device) other than the water comprised within the non-foaming, hydrating composition. This method has the benefit of being environmentally friendly, since shaving may be performed using only the water within the composition itself and since the composition comprises low levels of surfactant. In such a case, since these compositions do not foam, a user may have difficulty tracking the progress of the shaving, that is establishing which area of skin has already been shaved and which has not (hereinafter referred to as “tracking”). As explained above, in such a case, an opacifier or colorant may be added to the non-foaming, hydrating composition to facilitate tracking. Any water dispersible or water soluble colorant may be used, such as an organic dye, an encapsulated organic dye or a metal oxide pigment.

In another embodiment, a conventional foaming shaving preparation can be applied to the skin prior to shaving with the present device. For the event that a user decides not to shave with a non-foaming, hydrating composition alone, then a foaming shave preparation may additionally be applied before shaving. The use of two such compositions may allow the provision of benefits which cannot be achieved using a single composition alone.

When mixed with foaming shave preparations which can already be present on the face prior to the use of the present device, the non-foaming, hydrating compositions used in the method of the invention can give rise to a rich, creamy mixture. It is known that the presence of hydrophobic components, such as oil, may reduce the stability of a foam. Low oil or oil-free non-foaming, hydrating compositions as defined herein tend not to collapse the subsequently applied foam. This can facilitate better tracking.

Without intending to be bound by theory, it can be preferable to use this device and composition without further rinsing off the composition after use. The present composition is designed to provide hydrating benefits and be less irritating to skin, as such, it can be useful in a dry shave or wet shave usage. In one embodiment, the user is instructed not to rinse off the treated surface after shaving.

According to a further aspect of the invention a kit is provided comprising (a) the product dispensing device of the present invention and (b) a foaming shave preparation. The use of the elements of the kit in the defined way may provide a better shave than the use of a foaming shave preparation alone, because it achieves a different shaving experience.

b. Composition Turbidity

In one embodiment, the personal care composition comprises a turbidity of below about 320 NTU, alternatively less than about 250 NTU, alternatively less than about 200 NTU, alternatively less than about 150 NTU, alternatively less than about 100 NTU, as measured by Turbimeter test method disclosed herein. Compositions with a turbidity below about 150, alternatively below about 100 are considered “clear” while those with a turbidity below about 320, alternatively below about 250 are “translucent.” In one embodiment, the turbidity is determined when the composition is at rest. In another embodiment, the turbidity is measured within five seconds from when the composition is dispensed from the composition dispensing device.

As used herein, turbidity is determined using a Hach Model 2100AN Turbidimeter (“Turbimeter”), by Hach Company, Loveland, Colo. StablCal is a trademark of Hach Company.

Turbidimeter Turbidity Method: The Turbidimeter measures the turbidity from 0.1 NTU to 7500 NTU. The Turbidimeter operates on the nephelometric principle of turbidity measurement. The Turbidimeter's optical system includes a tungsten-filament lamp, a 90° detector to monitor scattered light and a transmitted light detector. The Turbidimeter's microprocessor calculates the ratio of the signals from the 90° and of transmitted light detectors. This ratio technique corrects for the interferences from color and or light absorbing materials and compensates for fluctuations in the lamp intensity.

Calibration is by StablCal® Secondary standards provided with the Turbidimeter. The undiluted sample is contained in the sample cell, the outer cell wall is wiped free of water and finger prints. A thin coat of silicone oil is applied to the outer wall of the sample cell in order to mask minor imperfections and scratches on the sample cell wall, which may contribute to turbidity or stray light. A measurement is taken and result is displayed in NTU units. All samples are equilibrated and measured at 25° C. The samples are measured within 24 h after making.

In one embodiment, the composition contained within the device can be something other than the non-foaming, hydrating composition disclosed above. In one embodiment, the composition dispensing device contains a shaving preparation as disclosed in U.S. Patent Publ. No. 2011/0272667.

### Lipophilic Skin Conditioning Agent

Shave preparations of the present invention can employ one or more lipophilic skin conditioning agents. The concentration level of the skin conditioning agents either singularly or collectively may range from about 0.1% to about 12% by weight of the base composition. Some preferred concentration levels include greater than about 1%, from about 2% to about 5%, and from about 2% to about 4%. It is to be understood that the scope of appended claims that do not specify a concentration level of the lipophilic skin conditioning agent is not limited to the levels described in this paragraph.

Exemplary skin conditioning agents include hydrocarbons, polymeric hydrocarbons, esters, ethers, and silicones selected from the group consisting of alkyl ethers, mineral oil, isoparaffin, greater than C20 hydrogenated polyisobutene, and petrolatum; and an ester composed of a branched C16-C22 alkyl chain and a mono alkyl group consisting of a linear or branched C1 to C6 alkyl chain. Some preferred skin conditioning agents comprise isostearic acid derivatives; for example, isostearyl isostearate, isopropyl isostearate, and mixtures thereof, PPG-15 Stearyl Ether and dimethicone. Other skin conditioning agents known to the skilled artisan may also be employed depending on the form of the personal care composition and the targeted skin benefit.

The skin conditioning agents may also help to reduce the coefficient of friction for personal care compositions provided herein that are in the form of shaving compositions. The reduction in friction can decrease the potential for skin irritation that can arise from contacting the skin one or more times with a razor blade. Employment of the skin conditioning agent in this context may also permit formulation flexibility regarding the type and concentration level of lubricants (as discussed more fully below) that are included in the shaving preparations.

In one embodiment, the shave preparations of the present invention is free or substantially free of any cationic skin conditioning agents, including but not limited to cationic polymers and cationic ammonium salts. Examples of such skin conditioning agents include substituted quaternary ammonium compounds (i.e., quaterniums, stearalkonium chloride, and guar hydroxypropytrimonium chloride.) See U.S. Pat. No. 4,586,650 at col. 2 line 54 et seq for additional examples of cationic skin conditioning agents which are preferably limited or not used in the present invention. Importantly, the present invention is able to achieve a desirable shave experience without requiring said cationic skin conditioning agents. This has been found to provide desired shave performance while reducing formulation costs and complexity. As defined herein, “substantially free” means that no amount of said ingredients intentionally added into the composition, but allowing for trace amounts which may be carried over from other ingredients or from processing conditions.

### Thickening Agent (Including Thickeners and Gelling Agents)

The shave preparations of the present invention may contain one or more thickening agents, from about 0.05% to about 5%, alternatively from about 0.1% to about 4%, alternatively from about 0.25% to about 3%, by weight of the composition.

Nonlimiting classes of thickening agents include those selected from the following: Carboxylic Acid Polymers, Crosslinked Polyacrylate Polymers Polyacrylamide Polymers, Polysaccharides, Clays and Gums, and mixtures thereof when appropriate.

In one embodiment, compositions of the present invention include a thickening agent selected from carboxylic acid polymers, crosslinked polyacrylate polymers, polyacrylamide polymers, polysaccharides, and mixtures thereof, more preferably selected from carboxylic acid polymers, polyacrylamide polymers, polysaccharides, and mixtures thereof.

### Emulsifier

The shave preparations of the present invention may contain one or more emulsifying agents, from about 0.05% to about 8%, alternatively from about 0.1% to about 5%, alternatively from about 0.25% to about 3%, by weight of the composition.

Nonlimiting examples of surfactants for emulsification for use in the compositions of the present invention are disclosed in McCutcheon's, Detergents and Emulsifiers, North American edition (1986), published by allured Publishing Corporation; and McCutcheon's, Functional Materials, North American Edition (1992). Preferred emulsifiers are nonionic surfactants/emulsifiers. Nonlimiting useful emulsifiers herein include those selected from the group consisting of alkyl glucosides, alkyl polyglucosides, polyhydroxy fatty acid amides, alkoxylated fatty acid esters, sucrose esters, alkoxylated fatty alcohols, amine oxides, and mixtures thereof.

### Lubricants

Shave compositions of the present invention may employ one or more lubricants, from about 0.05% to about 8%, alternatively from about 0.1% to about 5%, alternatively from about 0.25% to about 3%, by weight of the composition.

Exemplary lubricants include lubricous water soluble polymers, water insoluble particles, and hydrogel-forming (or water swellable) polymers, and mixtures thereof.

Useful lubricious water soluble polymers may have a molecular weight greater between about 300,000 and 15,000,000 daltons, preferably more than about one million Daltons. Nonlimiting examples of suitable lubricious water soluble polymers include polyethylene oxide, polyvinylpyrrolidone, and polyacrylamide. Nonlimiting useful water insoluble particles may include inorganic particles or organic polymer particles. Hydrogel-forming polymers are typically highly hydrophilic polymers that, in water, form organized three-dimensional domains of approximately nanometer scale. Additional polymer lubricants include: cellulose derivatives such hydroxyalkyl cellulose polymers such as hydroxyethyl cellulose and hydroxypropyl cellulose, carboxymethyl cellulose, and cellulose methyl ether and polysaccharide gums such as, for example, xanthan gum, carrageenan gum, guar gum, locust bean gum, and hydroxypropyl guar gum.

### Gel Network

In one embodiment, the shave composition is substantially free from a gel network. As used herein, the term “gel network” refers to a lamellar or vesicular solid crystalline phase which comprises at least one fatty amphiphiles. In one embodiment, the present invention contains less than about 5%, alternatively less than about 3%, alternatively less than about 1%, alternatively less than about 0.5% of at least one fatty amphiphiles. Gel networks have been found to reduce the rinse profile of these systems. Fatty alcohol gel networks have been used for years in cosmetic creams and hair conditioners. Gel networks are a re-solidified liquid crystal gel phase formed by fatty amphiphiles (e.g. cetyl or stearyl alcohol) and a hydrophilic phase (e.g. water). It is formed by undergoing a melting and then re-solidification process in the hydrophilic phase. The gel network will typically have a lower thermal transition than the melt temperature of the fatty amphiphile itself.

Non-limiting examples of such shaving preparations and methods of making such are described in U.S. Patent Publ. No. 2010/0272667.

2. Composition Dispensing Device

The composition dispensing device of the present invention can be any such device which allows the present composition to be dispense therefrom during the hair removal process. Examples of many types of composition dispensing devices are known. In one embodiment, the composition dispensing device is a composition dispensing razor comprising one or more safety razors.

In one embodiment, the device is an automatic vibrating and/or dispensing razors. For example, U.S. Patent Publ. no. 2008/0289185 to Clark which discloses a razor comprising a fluid delivery system having an electrically actuable dispensing device to control delivery of the fluid, and a control device for controlling actuation of the dispensing device. The control device is in proximity or is touch sensitive and includes a sensor element arranged to be brought into contact with or into close proximity to the skin being shaved during the performance of a shaving stroke. Another suitable device is disclosed in U.S. Pat. No. 7,441,336 to Hawes et al, which discloses an automated razor which has a control device allowing for automated vibration or dispensing when a certain environmental condition is met, such as proximity or touch with the intended surface or electrical conductance. These types of automated dispensing devices can be particularly useful so that the composition can be dispensed at the desired time onto the skin, thereby minimizing wasted product which could otherwise be captured within the device head or elements thereof. Further, using an automated device may be advantageous as users may have a difficult time deciding when to trigger the dispense action during the hair removal process. For example, they may accidently trigger the dispense too early or excessively, causing an undesirably large amount of composition to come out and potentially miss the intended surface for treatment. Automated dispensing, however, is not required, as manual dispensing systems can also be useful for certain purposes.

Non-limiting examples of other composition dispensing devices suitable for use with the present invention include those disclosed in U.S. Patents Publications 2006/00240380 to Chenvainu et al; 2007/0084074 to Szczepanowski et al; U.S. Pat. Nos. 7,127,817; 7,121,754; and 6,789,321. In some of these examples, the product can be dispensed at or about the vicinity of the device head (commonly a razor cartridge).

In one particularly useful embodiment, the composition can be dispensed through an elongated elastomeric contact region comprising a dispensing orifice which allows the composition to spread in a wide strip onto the surface, such as the lumens described in U.S. Patents Publications 2006/00240380 to Chenvainu et al (see inter alia FIG. 17). Similar dispensing systems have also been described in U.S. Ser. No. 61/340,299 to Royle et al, filed Mar. 15, 2010. The lumens or dispensing orifice can be particularly useful when dispensing the present non-foaming hydrating composition given the specific rheology (thickness and viscosity) desired for use herein. In particular, since the non-foaming hydrating composition is desirably thick and viscous, an elongated dispensing orifice or a plurality of orifices oriented to dispense a wide yet thin layer of the composition may be desired. Advantageously, the layer of composition deposited does not excessively run or drip off the surface prior to the treated surface coming in contact with the razor blade or other hair removal head. Further, where the composition is clear or translucent, the user can easily see where they are shaving so they can have fine control to make clean shaven areas such as a beard line. This can be particularly beneficial over devices comprising shaving heads with rotary blades which would not be as capable of allowing for fine control to make clean shaving lines.

In one embodiment, the composition dispensing device comprises a handle connected to a hair removal head, the handle further comprising a cavity for housing said non-foaming hydrating composition disposed within the handle, and an actuator adapted to displace non-foaming hydrating composition from the cavity to a fluid dispensing member, and wherein said fluid dispensing member comprises an elongated elastomeric contact region forming at least one dispensing orifice which is generally perpendicular to a transverse centerline of the handle. The fluid dispensing member may extend to or adjacent to the bottom portion of the hair removal head allowing for direct contact or near direct contact to a user's skin during application of the hair removal head to skin, such as during a shaving stroke. The fluid dispensing member comprises a fluid dispensing member comprising at least one elongated elastomeric contact region. In one embodiment, the fluid dispensing member also comprises a one-way valve, which can be formed from said elongated elastomeric contact region. Those of skill in the art will understand that the elastomeric material forming the flap valve, slit valve or duckbill valve is such that upon contact with skin, the valve will deform and allow said one or more dispensing orifice(s) to allow fluid to dispense.

In one embodiment, said elongated elastomeric contact region forms a one-way valve which will only allow the composition to exit so entry of undesirable contaminants into the plumbing or cavity of the device is minimized Non-limiting examples of suitable one-way valves include: check valves such as diaphragm check valves, swing check valves or tilting disc check valves, stop-check valves, lift-check valves, flap valves, slit valves, and/or a duckbill valve. In one embodiment, the fluid dispensing member forms at least one, but optionally two or more dispensing orifices at the dispensing end of the elongated elastomeric contact member for delivering said fluid from the cavity onto skin prior to hair removal. To prevent the fluid from leaking, the fluid flow path, along with any or all of the dispensing orifice(s) may comprise a check valve.

In another embodiment, the cavity can have multiple compartments. For example the cavity can have a first compartment containing said non-foaming hydrating composition, and wherein said cavity forms a second compartment for a second composition. In another embodiment, the device comprise multiple cavities, where different compositions can be contained therein. In one embodiment, the second skin care composition is selected from the group consisting of an aftershave, a lotion, a balm, a fragrance, or a mixture thereof. Examples of known dispensing devices which allow for multiple compositions to be contained therein include: U.S. Pat. Nos. 6,986,207; 5,855,066; and 4,129,942. In one embodiment, the non-foaming hydrating composition can be used with a device capable of dispensing multiple compositions such as therein described.

a. Hair Removal Head

The hair removal head can include a wide scraping surface such as where the composition dispensing device is used with a depilatory, or a razor cartridge where the device is a shaving razor. The hair removal head may be replaceable or pivotally connected to a cartridge connecting structure. In an aspect, the cartridge connecting structure includes at least one arm to releasably engage the hair removal head.

Where the hair removal head is a razor cartridge the cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201.

b. Fluid Dispensing Member

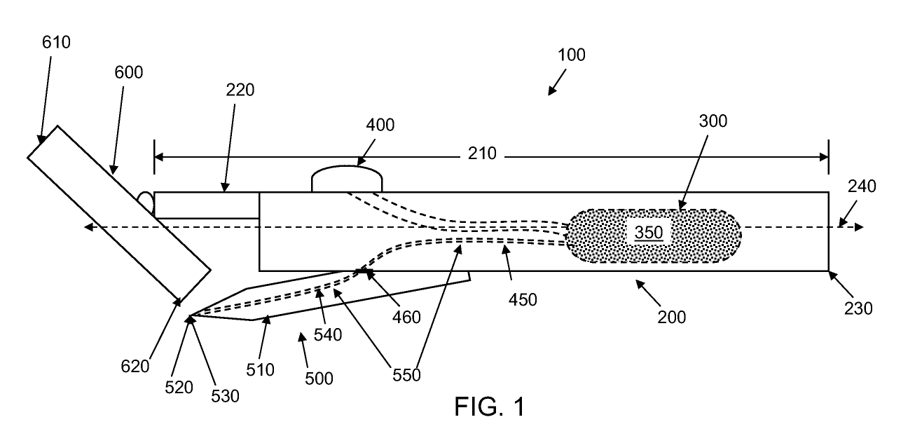

The fluid dispensing member of the present invention comprises an elongated elastomeric contact region. Non-limiting examples of suitable elongated elastomeric contact regions include: dual slit or duckbill valves such as those described in U.S. Patent Pub. 2006/00240380 in FIGS. 1-9 and paragraphs 52 to 58. The present invention, however, does not require dual lumens to be present, further, the present fluid dispensing member is designed to deliver fluid away from, preferably preceding, the head area of the personal care devices disclosed in the past. By delivering fluid prior to the skin contacting the hair removal head, it allows for broader spreading of the fluid and additional time where the fluid can come into contact with the folds and crevices within the skin. In one embodiment, the fluid dispensing member further comprises a non-elastomeric portion which can precede said elongate elastomeric contact member. The non-elastomeric portion can be formed of the same material as used to form any part of the remainder of the handle. In one embodiment, the one-way valve is not formed in said elongated elastomeric contact member. The one-way valve can be formed in the non-elastomeric portion of said fluid dispensing member or in any portion of said fluid flow path, such as in the supply channel, at the opening, and/or in the fluid dispensing path.

“Elongated” as defined herein means, that the object has a major and a minor axis, wherein the major axis is at least 10 times larger than the minor axis. The elongated portion of the fluid dispensing member has a width (major axis) which is at least 10 times larger than the height. In one embodiment, the width measures from about 2 cm to about 15 cm, alternatively from about 3 cm to about 10 cm, alternatively from about 4 cm to about 8 cm. In another embodiment, the height of the elongated one-way elastomeric valve is about 1 cm, alternatively about 0.5 cm, alternatively from about 0.2 cm, alternatively the elongated one-way elastomeric valve is biased to be in a sealed orientation when not in use. Those of ordinary skill in the art will understand that a check valve may be used in embodiments where the elongated one-way elastomeric valve is not sealed when not in use to minimize product leakage. In another embodiment, the fluid is chosen such that even if the height of the valve is such that it remains unsealed and open when not in use, the fluid is sufficiently viscous and thick that it will not undesirably leak when not being actuated by the user.

“Elastomeric” as defined herein means a material which is generally flexible and deformable. In one embodiment, the elongated elastomeric contact member has a young's modulus of elasticity of from about 0.01 GPa to about 3.5 GPa, alternatively from about 0.02 GPa to about 2 GPa, alternatively from about 0.05 GPa to about 1 GPa, alternatively from about 0.1 GPa to about 0.5 GPa. Non-limiting examples of suitable materials which can be used to form the elastomeric contact member include rubber, silicone, Teflon, and polyethylene. Without intending to be bound by theory, it is believed that by providing an elastomeric material in the fluid dispensing member at the point where the fluid dispensing member would contact skin is particularly useful as it decreases irritation onto skin from a non-elastomeric fluid dispensing member. Further, the elastomeric material allows the tip of the fluid dispensing member to deform to better engage the non symmetric shape of body parts. In one embodiment, the elastomeric material used has a shore hardness of from about 30 to about 40 D units.

“Slit valve” as defined herein means that the valve comprises a closed slit and flow is provided by flexing or deformation of the elastomeric material which causes the slit to open. In general the slit valve is a single piece construction which is free of moving parts. “Duckbilled valve” as defined herein is a type of slit valve, wherein one end of the valve is stretched over the outlet of the fluid dispensing path, conforming itself to the shape of the path, usually round. The other end, the duckbill, retains a natural flattened shape. When a fluid is pumped through the fluid dispensing path, the duckbill's flattened end opens to permit the pressurized fluid to pass. When pressure is removed, however, the duckbill end returns to its flattened shape, preventing backflow. Other check valves referred to herein are known in the art.

“Generally perpendicular” as defined herein means that the lateral dimension of the elongated elastomeric contact region forms an angle which is from about 75° to about 90° as measured against the transverse centerline passing through the handle. Since the elongated elastomeric contact region is generally elastic and therefore deformable in nature, this angle is measured when the fluid dispensing region is at rest and not deformed or otherwise manipulated by a user. The elongated elastomeric contact region comprises a contact point where the fluid dispensing member engages the surface (skin). In one embodiment, the contact point forms a straight line. In another embodiment, the contact point forms a concave or convex line. Similarly, “generally parallel” as defined herein means that the two straight lines formed through said objects are parallel or form an angle of from about 0° to about 15° when in a resting position.

The fluid flow path terminates at least one fluid dispensing orifice. In one embodiment, more than one fluid dispensing orifice is provided. The fluid dispensing orifice is formed of the elastomeric material used to form the elongated elastomeric contact member. Preferably, the fluid dispensing orifice has a wide and narrow shape similar to the fluid dispensing member but the fluid dispensing orifice can also be of different shapes. In one embodiment, the fluid dispensing member comprises a plurality of fluid dispensing orifices which are spaced out along the width of the elongated elastomeric contact member such that when fluid is dispensed, a wide flat application of fluid can still be deposited. The fluid dispensing orifices can be round, oval, triangular, square, rectangular in shape, or combinations thereof. In one embodiment, the portion of the elongated elastomeric contact member leading up to the fluid dispensing orifice forms a tapered exit channel, the tapering can be tapered in, or tapered out. Without intending to be bound by theory, it is believed that a tapered exit channel, particularly one that tapers out so the cross sectional area of the orifice is larger that the cross sectional area of the channel leading to the orifice, can be useful to ease in removal of any fluid which can reside in the vicinity of the orifice after use. A tapered in exit channel may be useful to minimize exposure of the fluid to contact with air, thereby minimizing fluid dry out.

c. Actuator

As explained above, the actuator can be manual or automatic pump (battery powered or via an external power source). The pump includes a wall, either movable or rigid, upon which force is acted upon to move the fluid through. In the case of a movable wall, the movable wall may be located on one or more of an upper or lower surface of the handle. For a rigid wall, the force causes the movement of non-rigid sidewalls of the pump to move a fluid through to the channel.

In one embodiment, the actuator is a manually-actuated pump which can reside on the handle. In another embodiment, the actuator is automated and can be powered by a battery or external power source. In yet further embodiments, the actuator comprises a pump which is actuated by movement of the shaving head (such as where depression of the head or rotation of the head about the pivot axis), actuates the pump. In yet another embodiment, the fluid dispensing member itself can be spring loaded and retractable upon contact with a surface such as skin such that the movement of the fluid dispensing member can act as the actuation to actuate the pump. Those of skill in the art will understand that in this type of embodiment, it could be preferred to have the elongated elastomeric contact region extend beyond the general plane of the shaving head such that when the device is brought into contact with a surface (such as skin) the fluid dispensing member will be pushed back towards the razor prior to surface contact with the shaving head. The movement of the fluid dispensing member can then actuate the pump permitting fluid to escape or be driven out of the cavity through the fluid flow path, out of the at least one dispensing orifice, ultimately onto the skin.

Other features and advantages of the invention will be apparent from the description and drawings, and from the claims.

3. Figures

FIGS. 1-4 provide side views of composition dispensing devices which are in accordance with at least one embodiment of the present invention. Composition dispensing device (100) is suitable for dispensing a fluid during the hair removal process, such as shaving. The composition dispensing device (100) includes a handle (200) and a hair removal head (600), such as a disposable razor cartridge. Hair removal head (600) includes a top portion (610) and a bottom portion (620). Those of skill in the art will understand that the composition dispensing device can be a wet or dry, manual or powered razor, having straight or rotary blades. In addition, the composition dispensing device can be used with a depilatory, therefore not requiring the use of razor. The handle (200) has a length (210) that extends from a proximal end (220) to a distal end (230) and a transverse centerline (240) which runs along the central axis of the handle. The handle comprises a cavity (300) for housing a fluid (350) disposed within the handle, and an actuator (400) adapted to displace the fluid from the cavity through a supply channel (450) to an opening (460) formed in said handle, such as towards the proximal end of the handle.

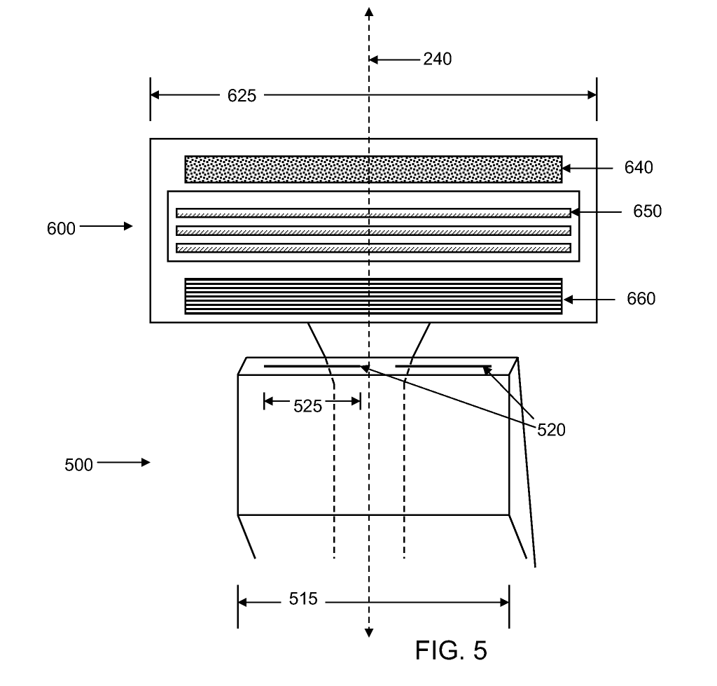

The composition dispensing device (100) includes a fluid dispensing member (500) comprising an elongated elastomeric contact region (510) forming at least one dispensing orifice (520) in fluid communication with said opening (460) formed in said handle (200). Said elongated elastomeric contact region comprises a lateral dimension (515), shown in FIG. 5, which is generally perpendicular to said transverse centerline (240) of the handle. The hair removal head also has a lateral dimension (625) which his generally perpendicular to said transverse centerline. In one embodiment, the ratio of the lateral dimension of the elongated elastomeric contact region (515) to the lateral dimension of the hair removal head (625) is from 1:10 to about 1.5:1, alternatively from about 0.5:1 to about 1:1. Without intending to be bound by theory, it is believed that by providing an elongated elastomeric contact region which is laterally sized with respect to the hair removal head as recited herein, the fluid dispensed from said at fluid dispensing member covers a sufficiently broad portion of said hair removal head to provide suitable product spreading over skin and into cracks and corners of the skin. The fluid dispensing member is in fluid communication with said cavity via said opening, forming a fluid dispensing path (540), wherein said supply channel and said fluid dispensing path form a fluid flow path (550).

In one embodiment, the device includes at least one one-way valve (530) located at some point along said fluid flow path. As explained above, in some embodiments, said elongated elastomeric contact point forms said one-way valve. Additional one-way valves can also be included along the fluid flow path as desired.

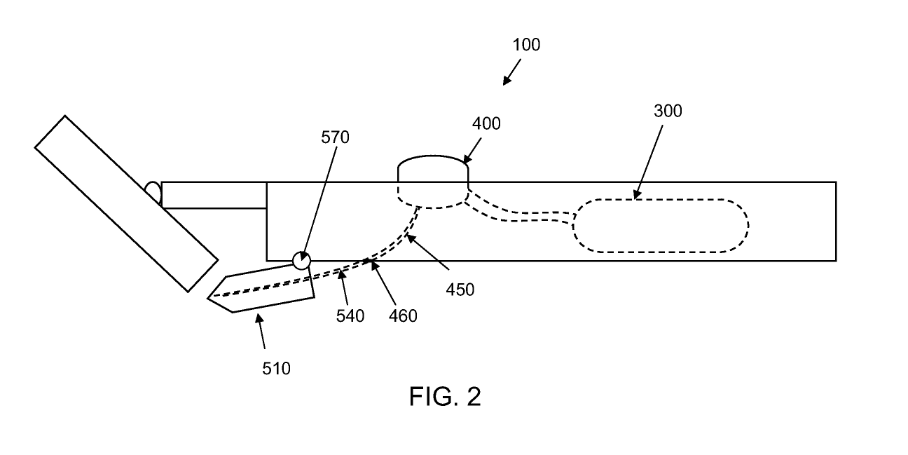

The actuators shown in FIGS. 1-4 are manual pumps but automatic pumps can also be included. The actuators shown in FIGS. 1-4, which can be manual or automatic, and may include pumps which can be stacked (and substantially flat) components and particularly a movable wall that acts to activate the flow of fluid from the cavity through channel and to the opening. A pump suitable for use in the present invention is disclosed in U.S. Pat. No. 5,993,180. In particular, this pump includes a pump chamber bounded by the movable wall, an inlet channel and an outlet channel, both of which are connected to the pump chamber, an inlet valve for closing the inlet channel, and an outlet valve for closing the outlet channel. In most instances, the pump may be actuated by the pressure exerted by a user's finger such that the user may easily determine the requisite amount of fluid for one or more shaving strokes. Because the valves of the pump are automatically opened when pressure is applied by the user's finger pressure, the fluid can be dispensed in controlled and metered quantities without relying on judgment or dexterity of the user. It is also possible to place one or more movable walls of the pump on an upper surface or lower surface of the razor depending on a user's preference. The actuator of FIG. 1 is shown providing a feed into the cavity. This feed can be application of pressure or another impulse which will drive fluid through said fluid flow path out to the fluid dispensing member. The actuator shown in FIG. 2, however, has a receiving chamber where fluid is transferred prior to entering the supply channel and passing into the fluid dispensing member. These and other actuators and pumps which are known in the art for use in personal care devices which dispense fluids can be used in accordance with the present invention.

The cavity (300), or at least a container/sachet within the cavity (300), contains the fluid (350) to be dispensed during the hair removal process. In one embodiment, the fluid (350) in the cavity or container is refillable or replaceable.

FIG. 2 provides a side view, where the fluid dispensing member is pivotably attached to said handle via a hinge member (570) positioned on said handle. Further, as shown in this figure, in one embodiment, a portion of the fluid flow path, such as the fluid dispensing path (540) can be exposed upon exiting said opening (460) formed in said handle.

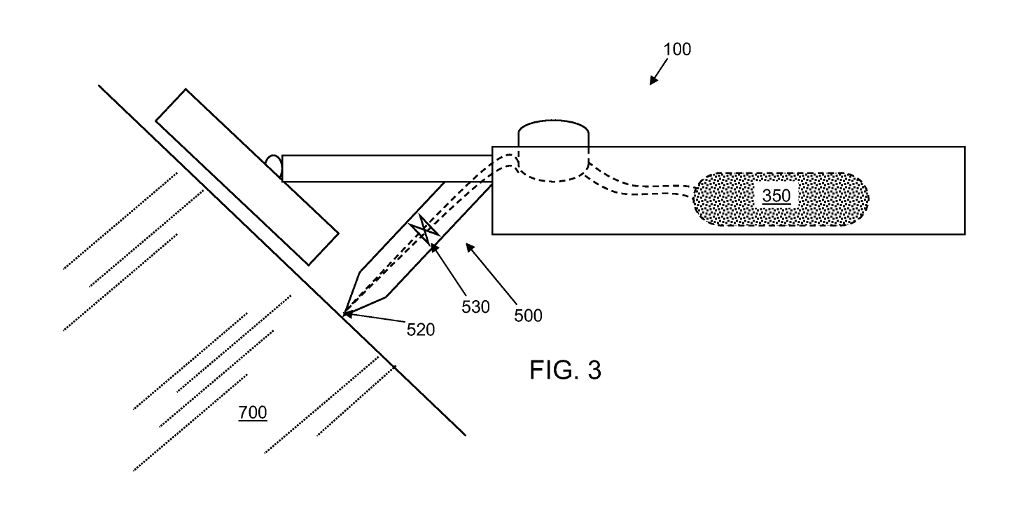

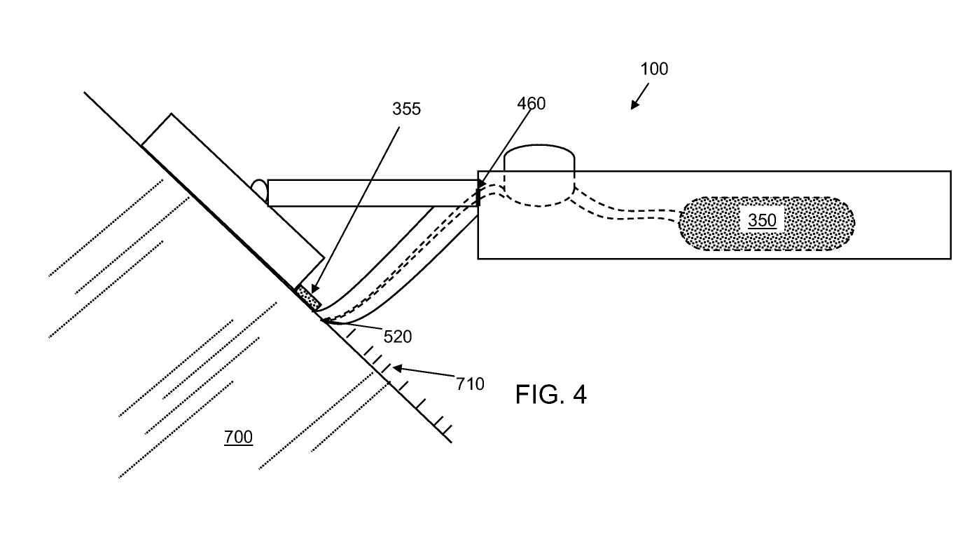

FIGS. 3 and 4 provide two exemplary side views of a composition dispensing device wherein the fluid dispensing member is shown deforming. In FIG. 3, the fluid dispensing member (500) is shown extending beyond the general facial plan formed by said hair removal head. Since the fluid dispensing member comprises an elastomeric contact region, the portion of the fluid dispensing member which extends beyond the plane of the hair removal head would deform, as generally depicted in FIG. 4 when the device comes in contact with a surface, such as skin (700). In FIG. 4, a fluid dispensing member is deformed when the device is in an “in-use” position, allowing fluid to exit the at least one dispensing orifice (520) formed in the elongated elastomeric contact region. The elongated elastomeric contact region can flex toward the hair removal head, flex away from the hair removal head and can even come into contact with a portion of the hair removal head, all depending on the movement of the device with respect to the surface. A volume of fluid (355) is deposited onto the skin and the hair removal head is moved in a downward trajectory along the skin to remove hairs (710) which have been treated with said fluid. Further, the one-way valve shown in FIG. 3 is positioned along the fluid flow path but not at the point where the fluid dispensing member forms said at least one dispensing orifice

The cartridge (600) attaches to the rear surface of a housing (not shown) by a cartridge connecting structure (not shown). The cartridge connecting structure may include one or more arms that extend to provide pivotal support of the housing. Alternatively, the cartridge connecting structure may include an ejection mechanism (e.g., a button) to disengage the housing from the cartridge connecting structure. Non-limiting examples of suitable housings and cartridge connecting structures are described in: U.S. Pat. Nos. 7,197,825, 5,822,869, 6,161,287, and 5,784,790.

The razor cartridge (300) may also include a guard (330) or lubricating strip located between the top portion (204) and bottom portion (206). The guard (330) is useful for stretching the skin's surface immediately prior to engagement with the blade or a first blade (when more than one blade is present). This guard (330) may typically comprise an elastomeric member to allow for an engagement that is comfortable to a user. U.S. Pat. No. 7,168,173 discloses a suitable razor cartridge and elastomeric material without the apertures. The elastomeric material can be selected as desired. Typically, the elastomeric material used is a block copolymer (or other suitable materials), e.g., having a durometer between 28 and 60 Shore A.

The shaving aid, also known as a lubricating strip, on the other hand, provides an additional treatment to the skin after contact between the fluid and the skin has occurred. The lubricating strip may contain the same or additional skin ingredients to those that are present in the fluid. Suitable shave aids/lubricating strips are disclosed in U.S. Pat. Nos. 7,069,658, 6,944,952, 6,594,904, 6,182,365, D424,745, 6,185,822, 6,298,558 and 5,113,585. The cartridge connecting structure (312) may be releasably engaged from the handle (300), as disclosed in U.S. Pat. Nos. D533,684, 5,918,369, and 7,168,173. This disengagement of these two components allows for replacement of razor cartridges as the continued use of such cartridges causes blade dulling. Thus, such cartridges are replaceable and disposable at will by the user.

FIG. 5 provides a bottom planar view of a portion of a composition dispensing device in accordance with at lest one embodiment of the present invention. Hair removal head (600) is shown as a razor cartridge with a plurality of blades (650) and a shaving aid (640) as well as a guard (660). The razor cartridge is shown having a lateral dimension which can measure any length typically used for conventional straight blade wet razor cartridges, for example from about 2 cm to about 10 cm, alternatively from about 3 cm to about 8 cm, alternatively from about 4 cm to about 7 cm. A transverse centerline of the handle is shown as (240). Said elongated elastomeric contact region (500) comprises a lateral dimension (515) which is generally perpendicular to said transverse centerline. In this embodiment, two fluid dispensing orifices are shown (520). Those of skill in the art will understand that different fluid dispensing orifice configurations are within the scope of the invention. FIG. 5 shows two fluid dispensing orifices which are equal in length and are positioned linear to one another. The lengths can vary and the orifices can be staggered so they do not sit on the same line. Further, although the at least one fluid dispensing orifice is shown being generally parallel to the angle of the razor cartridge and/or blades, the orifice can be angled. The lateral dimension of the at least one fluid dispensing orifice (525) is measured as the greatest lateral distance covered by the orifice, regardless of the angle upon which the orifice sits with respect to the razor cartridge and/or blades. In another embodiment, the at least one fluid dispensing orifice can have a curved or wavy line shape. In one embodiment, the ratio of the lateral dimension of the at least one fluid dispensing orifice (525) to the lateral dimension of the hair removal head (625) is from about 1:10 to about 1:1, alternatively from about 1:5 to about 1:2.

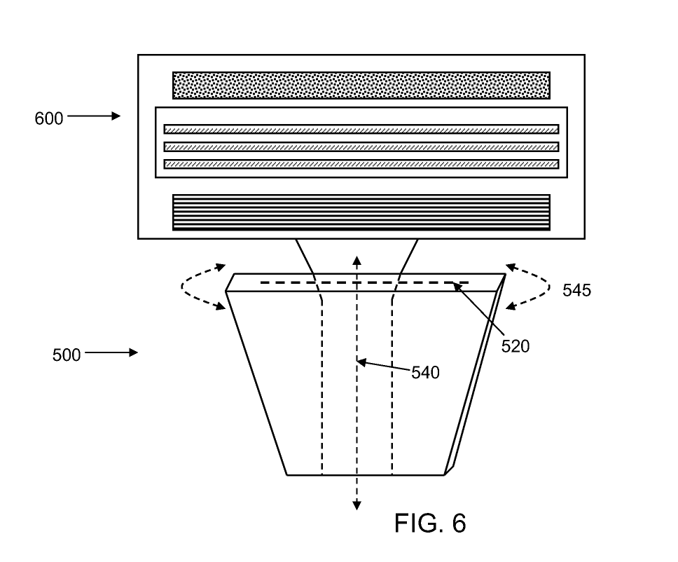

FIG. 6 provides a bottom planar view of a portion of a composition dispensing device in accordance with at least one embodiment of the present invention. The elongated elastomeric contact member is shown with a transverse central axis (540). The elongated elastomeric contact member, being deformable and elastic in nature can twist, bend, compress and stretch as needed. In this embodiment, the elongated elastomeric contact member has a rotation path (545) showing the ability of the elongated elastomeric contact member to rotate about said transverse central axis. In this embodiment, the portion of the elongated elastomeric contact member which forms the at least one fluid dispensing orifice (520) shown in a sealed position, has a greater lateral dimension than the portion of the elongated elastomeric contact member which would be closer to the handle. Those of skill in the art will understand that the elongated elastomeric contact member can have a constant, increasing or decreasing lateral dimension as the lateral dimension is measured from the distal end to the proximal end (towards the handle).

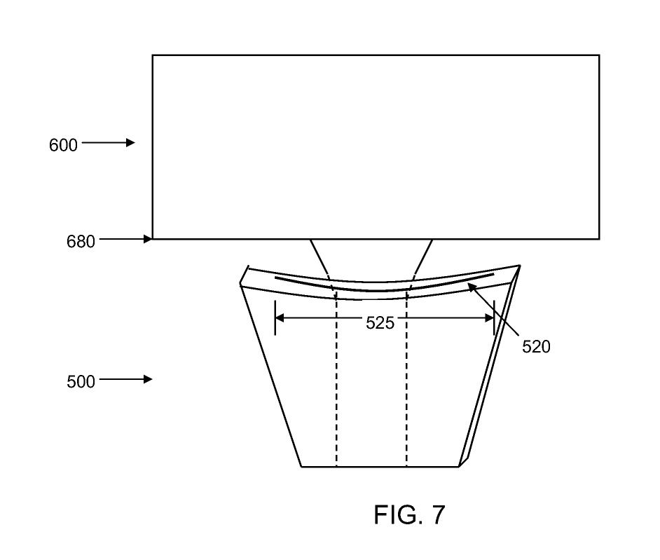

FIG. 7 shows another composition dispensing device in accordance with at least one embodiment of the present invention. In this embodiment, both the tip of the fluid dispensing member (500) and the at least one fluid dispensing orifice (520) are concave shaped so they can contour to body parts easier. The at least one fluid dispensing orifice is shown having a lateral dimension (525). This could be particularly preferable for female composition dispensing devices which are designed for use on the leg or arms. In this embodiment, the hair removal head (600) is shown having a scraping edge (680). The hair removal head can also be a razor cartridge as described above.

In one embodiment, the hair removal head has a skin contacting edge which is flat, concave or convex. Those of skill in the art will understand that different shapes for the skin contacting edge can be preferred based on the desired part of the body upon which the device is intended for use. For example, a composition dispensing device intended for use on the face may have an applicator having a straight edge. A composition dispensing device intended for use on legs may have an applicator having a concave edge. Non-limiting examples of suitable head configurations are disclosed in U.S. Pat. Nos. D399,601, D203,892, and 651,420 to Haglock; U.S. Pat. Nos. 3,088,470, 3,858,985, and 2004 0168743 A1 to Garwood; WO Publ. No. 97/18043A1 to Weiss; and GB 1 390 153 to Laboratorio Guidotti & C. S.p.A.

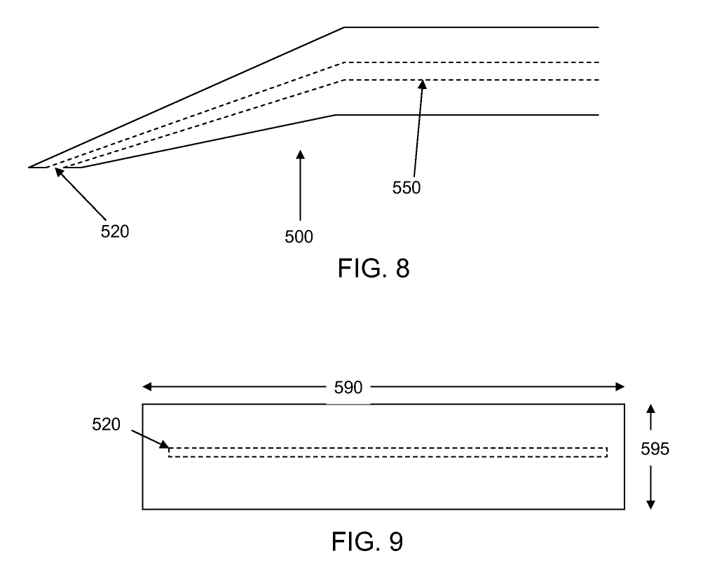

FIG. 8 provides an exploded side view of a fluid dispensing member (500) wherein the fluid dispensing member has an angled and tapered distal region (extending away from the handle). An fluid dispensing orifice (520) is shown in fluid communication with the fluid flow path (550). In one embodiment, a check valve is provided along the fluid flow path. In another embodiment, the fluid dispensing orifice can include a flap or be designed to close when not in use. The fluid dispensing orifice could then act as a one-way valve as described above. In one embodiment the fluid flow path has a constant cross sectional area or a varying cross sectional area. The fluid flow path shown in FIG. 8 is tapered as it approaches the fluid dispensing orifice.

FIG. 9 provides a planar view of the contact region which engages skin during use of a fluid dispensing member. The fluid dispensing orifice (520) is shown in dashed lines as it can be sealed when not in use. The width of the fluid dispensing member (590) is shown as well as the height of the fluid dispensing member (595). In one embodiment, the fluid dispensing orifice has a width of from about 2 cm to about 15 cm, alternatively from about 3 cm to about 10 cm, alternatively from about 4 cm to about 8 cm. Where numerous fluid dispensing members are provided, the width can be even smaller, as low as about 0.2 cm, or about 0.5 cm, or about 1 cm. The width of the fluid dispensing orifice is preferably 0 cm when the device is in a sealed state (not in use) but the width can change when the orifice is opened and can be from about 0.02 cm to about 0.5 cm, alternatively from about 0.05 cm to about 0.3 cm, alternatively from about 0.1 cm to about 0.2 cm. In one embodiment, the fluid dispensing orifice is not 0 cm when not in use. In this embodiment, a check valve can be included somewhere along the fluid flow path to control movement of the fluid before it reaches the fluid dispensing orifice. In another embodiment, the fluid dispensing orifice comprising a width of from about 0.5 mm to about 10 mm, or from about 1 mm to about 3 mm, and a length of from about 20 mm to about 80 mm, or from about 30 mm to about 70 mm, alternatively from about 40 mm to about 50 mm.

4. Methods of Use

As explained above, the present device is designed for use in the hair removal process, such as when shaving. One embodiment of the present invention provides for a method of removing hair from skin comprising the steps of: providing a composition dispensing device containing the non-foaming, hydrating composition described herein; actuating said composition dispensing device to dispense said composition; contacting said composition onto a portion of skin to be treated to form a prepared surface; and contacting said prepared surface with the composition dispensing device to form a treated surface.

Another embodiment, further comprises a step of wetting said portion of skin to be treated either before contacting said composition onto a portion of skin or after contacting said prepared surface with the composition dispensing device to form a treated surface. The process can also include a step of leaving the treated surface as is, without further washing or rinsing, after the hair removal step.

In another embodiment, the composition is dispenses from the device directly onto skin from the dispensing member of said composition dispensing device. This step can be by manually triggering an actuator, or by an automated control device which senses when the device is in proximity or in contact with the surface to be treated. The composition could also be dispensed onto a portion of the device which is then contacted to the skin to apply the composition but this is not necessary where dispensing directly on to skin is possible.

In yet another embodiment, the steps of contacting said composition onto the skin and contacting said treated surface with the razor blade can occur simultaneously.

In one embodiment, the device is used in a dry shave context and the user can allow the treated surface to dry without being contacted with water. Yet another embodiment provides for a further step of applying a second skin care composition onto the treated surface, such as a post-shave composition. These and other methods of use of the present device in a grooming context are within the scope of the present invention.

5. Non-Foaming Hydrating Composition Example

| Material | % wt |
|---|---|
| Deionised water | Qs |
| Carbopol ETD 2020¹ | 0.500 |
| DMDM Hydantoin and butyl carbamate | 0.400 |
| Glycerine | 1.000 |
| Panthenol | 0.500 |
| Disodium EDTA | 0.250 |
| Perfume | 0.150 |
| Triethanolamine | 0.680 |
| ZPT | 1.0 |

¹Supplied by Noveon

This formulation is made in the following way:

Heat the water and glycerine while stirring (at about 200 rpm) to 55° C. Then add disodium EDTA and continue stirring at 55° C. until it is fully dissolved. Then add and carefully disperse the Carbopol while stirring (at about 250 rpm). Remove from the heat and add the triethanolamine and continue to stir at 200 rpm. Then add the panthenol while continuing to stir at 200 rpm. When the temperature reaches 45° C., add the DMD Hydantoin/butyl carbamate and continue to stir for 5 minutes. Lastly, add the perfume and continue stirring for about 5 minutes, followed by 1 minute of high shear (at about 7500 rpm). ZPT can be added in any of the above steps and can also be added after the perfume but before the high shear mixing.

Other examples of compositions which can be used with the present device include those disclosed in U.S. Patent Publ. No. 2010/0272667 and U.S. Patent Publ. No. 2006/0239953.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern. Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition dispensing device comprising: a first chamber and a non-foaming, hydrating composition contained within said first chamber, said non-foaming, hydrating composition comprising:
a. at least about 80% water by weight of the non-foaming, hydrating composition;
b. sufficient thickener to give the non-foaming, hydrating composition a viscosity of at least 10,000 cps, and at most 200,000 cps measured using a Brookfield DVII Viscometer using a T-A spindle at 2.5 rpm at 25° C.;
c. less than about 1% hydrophobic components, by weight of the non-foaming, hydrating composition; and
d. less than about 1% surfactant, by weight of the non-foaming, hydrating composition.

2. The composition dispensing device of claim 1, wherein said non-foaming, hydrating composition has a turbidity value of below about 320 NTU.

3. The composition dispensing device of claim 1, wherein said non-foaming, hydrating composition comprises less than about 5% of a lubricating polymer.

4. The composition dispensing device of claim 1, wherein said non-foaming, hydrating composition comprises at least about 90% water.

5. The composition dispensing device of claim 1, wherein said non-foaming, hydrating composition is free of one or more lathering surfactants.

6. The composition dispensing device of claim 1, wherein said non-foaming, hydrating composition comprises less than about 5% alcohol.

7. The composition dispensing device of claim 1, wherein the thickener is selected from the group consisting of: carbopol, pumulen, and a mixture thereof.

8. The composition dispensing device of claim 1, wherein the thickener is present at a level of from about 1% to about 5%.

9. The composition dispensing device of claim 1, wherein the composition dispensing device comprises a handle connected to a hair removal head, the handle further comprising a cavity for housing said non-foaming hydrating composition disposed within the handle, and an actuator adapted to displace non-foaming hydrating composition from the cavity to a fluid dispensing member, and wherein said fluid dispensing member comprises an elongated elastomeric contact region forming at least one dispensing orifice which is generally perpendicular to a transverse centerline of the handle.

10. The composition dispensing device of claim 9, wherein said elongated elastomeric contact region forms a one-way valve.

11. The composition dispensing device of claim 10, wherein said one-way valve is selected from a flap valve, a slit valve, a duckbill valve, and a combination thereof.

12. The composition dispensing device of claim 9, wherein said cavity forms a first compartment containing said non-foaming hydrating composition, and wherein said cavity forms a second compartment for a second composition.

13. The composition dispensing device of claim 12, wherein said second skin care composition is selected from the group consisting of an aftershave, a lotion, a balm, a fragrance, or a mixture thereof.

14. A method of removing hair from skin comprising the steps of:
a. providing a composition dispensing device containing a non-foaming, hydrating composition comprising:
i. at least about 80% water by weight of the non-foaming, hydrating composition;
ii. sufficient thickener to give the non-foaming, hydrating composition a viscosity of at least 10,000 cps, and at most 200,000 cps measured using a Brookfield DVII Viscometer using a T-A spindle at 2.5 rpm at 25° C.;
iii. less than about 1% hydrophobic components, by weight of the non-foaming, hydrating composition; and
iv. less than about 1% surfactant, by weight of the non-foaming, hydrating composition;
b. actuating said composition dispensing device to dispense said composition;
c. contacting said composition onto a portion of skin to be treated to form a prepared surface; and
d. contacting said prepared surface with composition dispensing device to form a treated surface.

15. The method of claim 14, further comprising a step of wetting said portion of skin to be treated either before step c) or after step d).

16. The method of claim 14, wherein said step b) dispenses said composition directly onto skin.

17. The method of claim 14, further comprising a step of allowing said treated surface to dry without being contacted with water.

18. The method of claim 14, further comprising a step of contacting said treated surface with a second skin care composition.

19. The method of claim 18, wherein said second skin care composition is dispensed from the same composition dispensing device.

20. The composition dispensing device of claim 1, wherein said composition further comprises from about 0.01% to 5% of an anti-irritation agent comprising a pyrithione, a polyvalent metal salt of pyrithione, and a mixture thereof.

21. The composition dispensing device of claim 20, wherein said pyrithione is zinc pyrithione is in the form of a platelet having a median particle diameter of about 0.5 microns to about 10, a mean particle diameter of about 0.5 to about 10 microns, and a thickness of about 0.6 to about 15 microns.

22. The composition dispensing device of claim 21, wherein the zinc pyrithione is in platelet particle form having an average size of up to about 20 μm.

23. The composition dispensing device of claim 21, further comprising from 0.001% to 10% of a zinc salt.

24. The composition dispensing device of claim 1, wherein the composition further comprises:
a. from about 2% to about 4% of one or more lipophilic skin conditioning agents;
b. from about 0.25% to about 3% of one or more thickening agents;
c. from about 0.25% to about 3% of one or more emulsifying agents;
d. from about 0.25% to about 3% of one or more lubricants;
e. from about 0.25% to about 2.5% of an anti-irritation agent wherein said anti-irritation agent comprises zinc pyrithione, and
f. is substantially free of a gel network.
